(19) United States
(12) Patent Application Publication
(10) Pub. No.: US 2024/0386805 A1
(43) Pub. Date: Nov. 21, 2024

(54) METHOD OF DETERMINING A SET OF LANDING SITES FOR AN AIRCRAFT

(71) Applicant: Rockwell Collins, Inc., Cedar Rapids, IA (US)

(72) Inventors: Giovanni Franzini, Glanmire (IE); Naresh Yarlapati Ganesh, Cork (IE); Stefano Riverso, Cork City (IE)

(21) Appl. No.: 18/669,022

(22) Filed: May 20, 2024

(30) Foreign Application Priority Data
May 19, 2023 (EP) 23174365.9

(51) Int. Cl. G08G 5/02; G08G 5/00

(52) U.S. Cl. CPC G08G 5/025; G08G 5/0013; G08G 5/0039; G08G 5/006; G08G 5/0086

(57) ABSTRACT

A method of determining a set of landing sites for an aircraft includes retrieving a first map of the reachable area (300) surrounding the aircraft, converting data relating to a plurality of no-go zones into a second map (302), filtering the plurality of no-go zones from the first map using the second map to create a third map of potential landing sites (310), and identifying one or more feasible landing sites (312) from the third map based on one or more landing requirements of the aircraft.

### CROSS REFERENCE TO RELATED APPLICATIONS

The present application claims the benefit of European Patent Application 23174365.9, entitled METHOD OF DETERMINING A SET OF LANDING SITES FOR AN AIRCRAFT, filed on May 19, 2023, which is incorporated by reference in the entirety herein.

### FIELD OF TECHNOLOGY

The examples described herein relate to a method of determining a set of landing sites for an aircraft, in particular to emergency landing protocol and flight planning for an aircraft.

### BACKGROUND OF THE INVENTION

During flight of an aircraft, there may be an emergency onboard involving a threat to the safety of the passengers, such as a medical emergency or mechanical failure. In such an emergency, the aircraft may be required to perform an emergency landing, the timing of which is critical.

In order to land safely the aircraft, the pilot must send a request to air traffic control for a suitable landing area to be found and a flight path communicated, in a non-automated process. This may be time consuming, and may result in the aircraft not being landed in the best area with regards to safety and ease of landing.

Existing methods for planning a path for a forced landing of an aircraft based on image recognition do not take into account areas where it would not be safe to land for reasons aside from unsuitable terrain height.

There is therefore a need for an improved automated method for determining a suitable landing area in an emergency and generating a flight plan.

### SUMMARY OF THE INVENTION

According to this disclosure, there is provided a method of determining a set of landing sites for an aircraft, where the method comprises: retrieving a first map of a reachable area surrounding the aircraft; converting data relating to a plurality of no-go zones into a second map; filtering the plurality of no-go zones from the first map using the second map to create a third map of potential landing sites; and identifying one or more feasible landing sites from the third map based on one or more landing requirements of the aircraft.

Also according to this disclosure, there is provided a system for determining a set of landing sites for an aircraft, where the system comprises: a processor; where the processor is configured to: retrieve a first map of a reachable area surrounding the aircraft; convert data relating to a plurality of no-go zones into a second map; filter the plurality of no-go zones from the first map using the second map to create a third map of potential landing sites; and identify one or more feasible landing sites from the third map based on one or more landing requirements of the aircraft.

In an emergency, an aircraft will need to quickly identify safe landing sites where it is feasible to land. This may be required in the case of an onboard emergency which jeopardises the safety of the passengers, e.g., a mechanical fault or medical emergency.

This method and system may be applicable to any aircraft, e.g., a plane, helicopter, or unmanned aerial vehicle (UAV).

This involves retrieving a map of the reachable area surrounding the aircraft, where the reachable area includes regions the aircraft would be able to reasonably fly to in a short amount of time. The size of the reachable area may depend on the nature of the emergency, i.e., how quickly the aircraft needs to land, as if an emergency landing is required sooner, the reachable area may be smaller. In some examples, the weather conditions at the time of landing may impact the size of the reachable area.

In some examples, the reachable area is determined from an assessment of the aircraft's manoeuvrability. The manoeuvrability of the aircraft relates to how easy it is to change the course of the aircraft at the time of landing. This may be dependent on factors such as the specification of the aircraft itself, e.g., a helicopter may be more manoeuvrable than a large plane. The manoeuvrability may be dependent on how controllable the aircraft is as a consequence of a fault.

In some examples, the assessment of aircraft manoeuvrability uses data (and the method may comprise receiving data) corresponding to the steerability of the aircraft. The condition of the aircraft may impact its steerability and determine how much it is able to deviate from its original course. This data may arise from a compilation of the status of the various mechanical components of the aircraft. For example, if there is a fault onboard the aircraft such that it cannot steer left, landing sites which would require the aircraft to be steered to the left in order to be reached would be excluded from the reachable area.

In some examples, the reachable area is determined using data corresponding to at least one of the aircraft heading, track, course, altitude, or speed.

In some examples, the reachable area is determined using corresponding to the aircraft fuel levels. The fuel levels of the aircraft may limit how far it is able to travel to given landing site, or how much it is able to manoeuvre towards a given landing site, and may therefore limit the reachable area.

Within the reachable area, there will be zones where it would be unsafe, or unfeasible for the aircraft to land. These areas are known as ‘no-go zones’, and may include urban areas, military zones, and critical infrastructures such as airports, schools, colleges, hospitals, and any other places where the aircraft would not have enough space to land safely. The no-go zones may also include bodies of water, as it may be desirable for the aircraft to avoid ditching.

The first map, of the reachable area surrounding the aircraft, may be retrieved from (and thus, in examples, stored on) any suitable and desired storage location, e.g., memory. In some examples, the first map is stored in a memory of the system. Thus, in examples, the system comprises a memory. In some examples, the first map is stored in a memory on the aircraft, e.g., in a different system from the system that determines the landing sites.

The first map may be loaded onto the memory (e.g., on the aircraft or system) prior to a flight, such that it is able to be retrieved, when required during a flight, by the system. In some examples, the first map may be requested and transferred to the system at the point-of-use (e.g., when the aircraft needs to make an emergency landing). This may be transferred from another on-board system to the system that determines the landing sites, or from a ground-based system.

Data, such as co-ordinates, corresponding to the location of the no-go zones (e.g., in the areas surrounding the flight path) are stored, e.g., in the memory of the system of the aircraft. In some examples, the data relating to the no-go zones is stored in a memory on the aircraft, e.g., in a different system from the system that determines the landing sites.

In some examples, the data corresponding to the no-go zones is loaded in the memory of the system and stored prior to flight. In some examples, the data corresponding to the no-go zones is requested and transferred to the system at the point-of-use (e.g., when the aircraft needs to make an emergency landing). This may be transferred from another on-board system to the system that determines the landing sites, or from a ground-based system.

In the instance of an emergency landing, a map of the no-go zones is generated. This map is then overlaid onto the map of the reachable area, e.g., by an image processing software, in order to filter the no-go zones from the map of the reachable area and generate a filtered map.

In some examples, the filtered map is converted to an image where each pixel yields a precision of one square metre.

Using the filtered map, a list of feasible landing sites is identified by the system using one or more landing requirements of the aircraft. These landing requirement(s) may be already known to the system and be inherent to the aircraft itself.

In some examples, the landing requirement(s) include one or more (e.g., both of) the minimum length and width of a landing strip for the aircraft. This information may be used by an image processing software to generate a minimum sized virtual rectangle representing the area where the aircraft is able to land, which may be overlaid on to the filtered map. The image processing software may then identify regions of the filtered map where the aircraft would be able to land safely based on the minimum landing strip size.

In some examples, a footprint of the aircraft is overlaid on the map of the reachable area by the image processing software. This may allow the image processing software to determine the area required to land the aircraft. This may be useful if the minimum landing strip size of the aircraft is unknown.

In some examples, the map of the reachable area also includes data corresponding to a terrain of the reachable area. Therefore, in some examples a plurality of low-risk landing sites may be identified from the list of feasible landing sites by analysing the height-profile of the terrain to determine the surface condition of the landing site.

In some examples, the landing requirement(s) include the terrain the aircraft is able to land on. This may further filter the feasible landing sites for the aircraft, by eliminating zones with unsuitable terrain e.g., very bumpy areas.

In some examples, feasible landing sites are ranked. For example, the landing sites may be ranked from safest to least safe.

In some examples, the feasible landing sites are ranked in order of landing strip size (e.g., length, width and/or area). For example, a plane may require a longer, rectangular landing strip, whereas a helicopter or UAV may require a square or circular-shaped landing strip.

In some examples, the feasible landing sites are ranked based on the distance to the landing site and the manoeuvrability required. This may include ranking more highly those landing sites which are closer to the aircraft's current position, or ranking more highly those landing sites which require the minimum amount of manoeuvring of the aircraft, e.g., the landing site is in the current heading of the aircraft. In some examples, the ranking may be determined from a weighting of relevant factors, including at least two of the manoeuvrability of the aircraft required to reach the landing site, the current distance of the aircraft from the landing site, the area of the landing strip size, or the height-profile of the terrain of the landing site.

These factors may be important when automatically determining the best landing sites for the aircraft considering the nature of the emergency. For example, if the aircraft manoeuvrability is limited as a consequence of a control surface failure, only those landing sites that the aircraft can align to before landing will be selected.

In some examples, the highest-ranked landing site is selected, and a flight plan generated, e.g., by a flight management system of the aircraft, e.g., the method further comprises generating a flight plan using the selected landing site. The flight plan may find the best, fastest route to the selected landing site, and therefore may decrease the time for the aircraft to land.

The flight management system may be part of the system that determines the landing sites of the aircraft or vice versa, e.g., the system that determines the landing sites of the aircraft may be part of the flight management system. The flight management system and the system that determines the landing sites of the aircraft may be separate (albeit interconnected) systems.

It is desirable for this determining of landing sites to happen onboard the aircraft, in order to quickly provide the landing site to the (e.g., flight management) system of the aircraft and generate a flight plan to this landing site, without excessive communication with air traffic control, as there may be a delay in communications. This may give the aircraft significantly more time to land, e.g., 10 seconds, which is crucial in an emergency.

In some examples, the method of generating a flight plan is fully automatic and takes place completely within the (e.g., flight management) system of the aircraft.

In some examples, the method of selecting a landing site is fully automatic and takes place within the system that determines the landing sites of the aircraft (e.g., in an application external to the flight management system of the aircraft), with the landing site sent from the (e.g., application of the) system to the flight management system where the flight plan is generated.

In some examples, the flight plan is sent to an air traffic controller for approval. The flight plan must be approved for the aircraft is able to descend to the landing site, as there may be other factors which the (e.g., flight management) system has not been able to take account of which may prevent the aircraft from landing safely. This may include the presence of other aircraft in the area which may need to be warned about the emergency landing.

In some examples, if the flight plan is approved by the air traffic controller, it may be programmed into a system of the aircraft used by the pilot to land the aircraft safely.

However, in some examples the flight plan may be rejected by the air traffic controller. In these examples, the system may select another landing site from the list of landing sites, for example the next highest ranked site, and the (e.g., flight management) system may generate a new flight plan. This flight plan may then be sent to air traffic control for approval.

In some examples, where the air traffic controller rejects the flight plan more than once, the system will iterate through the ranked list of landing sites, the (e.g., flight management) system will generate flight plans and send them to air traffic control until a flight plan is approved.

In some examples, the process of negotiation of the flight plan with air traffic control may also be fully automated by the (e.g., flight management) system. This may allow the pilot to concentrate on other issues within the aircraft before the landing site is determined.

### BRIEF DESCRIPTION OF THE DRAWINGS

One or more non-limiting examples will now be described, by way of example only, and with reference to the accompanying figures in which:

FIG. 1 shows a flow chart of the process for automatic generation and negotiation of an emergency landing, in accordance with one or more embodiments of the disclosure.

FIG. 2 shows a flow chart of the process for identifying low-risk landing areas, in accordance with one or more embodiments of the disclosure.

FIG. 3 shows a map filtered using the process for identifying low-risk landing areas, in accordance with one or more embodiments of the disclosure.

FIG. 4 shows schematically a system for determining the landing sites of an aircraft, in accordance with one or more embodiments of the disclosure.

### DETAILED DESCRIPTION OF THE INVENTION

The examples described herein may be used for the planning of emergency landing of an aircraft. Other planning applications where there is not an emergency, however, are also envisaged and the examples are not limited to this.

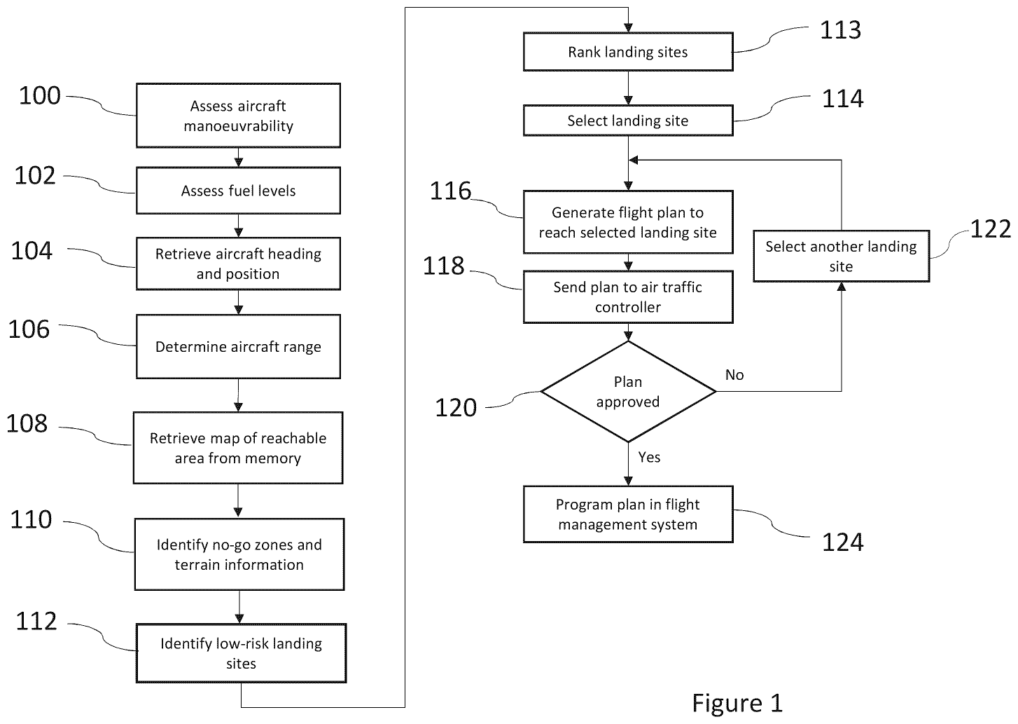

FIG. 1 depicts a flow chart of the process for automatically generating a flight path to a safe landing area and negotiation of this flight path with air traffic control (ATC). This process involves a sequence of steps which take place within a system of the aircraft. The system for determining the landing sites of an aircraft may include, be part of, or be separate from the flight management system of the aircraft.

At step 100 the system assesses the aircraft manoeuvrability. This accounts for any faults within the aircraft which may mean it is unable to perform certain movements, for example if the aircraft is unable to turn left.

The system also assesses the fuel levels of the aircraft (step 102) in order to determine where the aircraft is able to reasonably fly to, based on its average fuel consumption. This step may also consider the current flight conditions and whether these may require a higher fuel consumption in order to land safely, such that when the aircraft range is determined (step 106) it excludes the possibility of the aircraft running out of fuel before reaching a safe landing area.

The aircraft heading and position are retrieved by the system from the aircraft navigation system (step 104). This includes its coordinates, altitude, speed and current heading and track.

The information retrieved relating to manoeuvrability, fuel levels, heading and position (steps 100, 102, 104) is then considered when determining the range of the aircraft (step 106). By identifying the manoeuvrability of the aircraft (step 100), the system is able to note areas that the aircraft is unable to manoeuvre towards based on its current heading and position (as retrieved at step 104). For example, if the aircraft heading is north, the aircraft range may be determined (step 106) to only be an area to the east of the aircraft if it is unable to turn left. The range is then limited by the fuel levels determined (step 102).

Using the aircraft range determined (step 106), a map of the reachable area is then retrieved from a memory of the aircraft (step 108). The memory, which may be a memory of the flight management system, a memory of the system for determining the landing sites of an aircraft, or a memory of a separate system, may have a plurality of maps saved prior to flight to cover the surrounding area of the planned route of the aircraft. The relevant map based on the reachable area determined by the aircraft range (step 106) is then selected (step 108). Thus, the system may request the map of the surrounding area from another on-board system, and the map is then transferred to the memory of the system, or the system retrieves the map from its own memory.

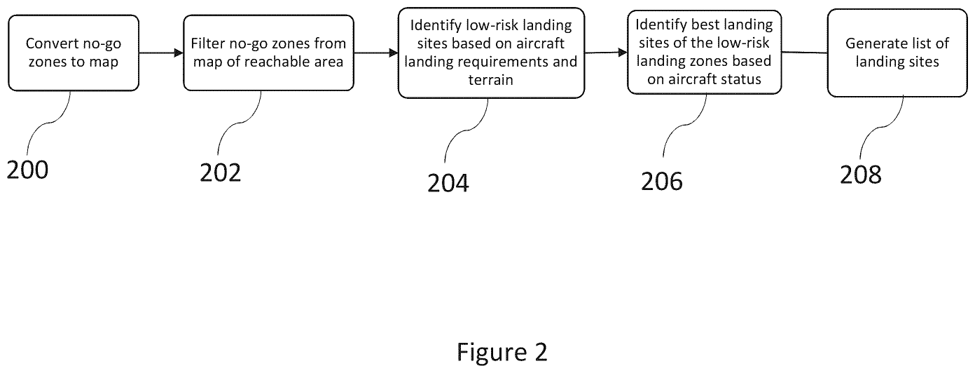

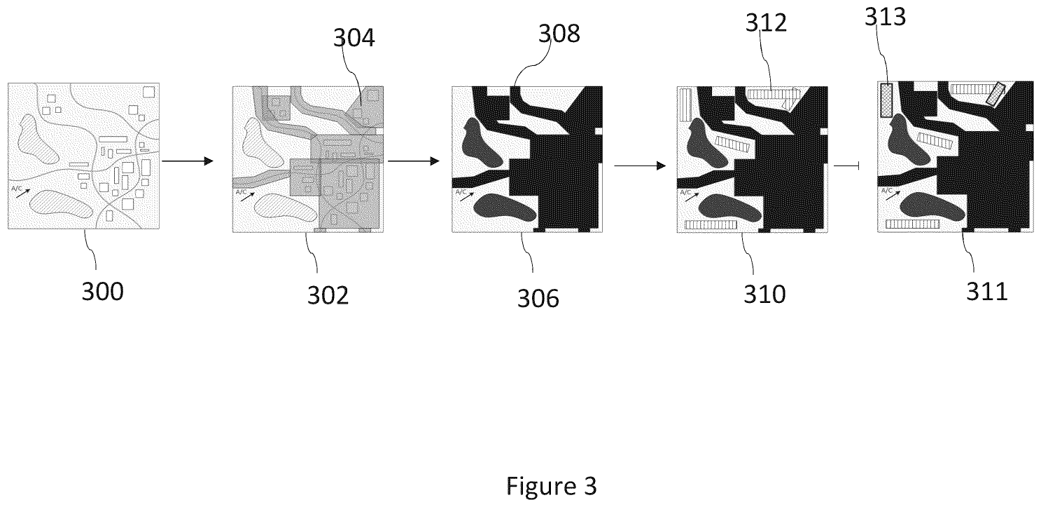

The system then uses the map retrieved (step 108) to overlay identified ‘no-go zones’ and terrain information (step 110). No-go zones may include areas such as bodies of water, buildings, highways, schools, hospitals, and other critical infrastructure, where the aircraft would not be able to land safely. Terrain information is also identified from the map of the reachable area, using information pre-saved to the system. This allows for areas, where the terrain means the aircraft would not be able to land safely, to be excluded from the map, as is described in more detail below with reference to FIGS. 2 and 3.

With the information retrieved (step 110) overlaid onto the map of the reachable area, the system is then able to identify low-risk landing sites and generate a list of the relevant zones (step 112). The low-risk landing sites include regions that are large enough for the aircraft to land safely based on its already-known parameters, including minimum landing strip size, which are identified from the map using image-processing software.

Where the aircraft is a plane, the image processing software fits a series of rectangles onto the regions identified as being safe to land, maximising the size of the rectangles to provide the largest landing strips possible for the available area. This is shown in FIG. 3. The co-ordinates of these landing sites are identified by the system. In the case of other aircraft, e.g., a helicopter or UAV, the image processing software may instead fit a series of squares and maximise their overall area, to provide the largest landing areas possible for the available area.

The landing sites are ranked (step 113). A landing site is then selected (step 114) from this ranking of the low-risk landing sites (step 113). The ranking is based on the suitability of the identified low-risk landing sites, for example, areas which have the largest landing strip size may be ranked highest, or areas with the flattest terrain, or regions which are aligned with the heading to minimise the manoeuvres the aircraft has to perform, or from a weighted combination of these factors to give a ranking of the safest places to land. For example, if the aircraft is a plane, areas with the longest landing strip size would be ranked more highly than those with a more square-shaped landing strip.

Once the landing site is selected, a flight plan is generated (step 116) by the (e.g., flight management) system, which gives the pilot of the aircraft instructions on how to reach the selected landing site. This will show the planned aircraft trajectory and route towards the landing site, as well as relative timings.

This flight plan is sent to air traffic control (step 118), where it is assessed by the air traffic controller (step 120). This assessment must take place at air traffic control as there may be aspects of the flight plan which are unsuitable but cannot be accounted for by the (e.g., flight management) system, such as the flight path of other nearby aircraft.

Air traffic control must approve the flight plan in order for it to be programmed into the (e.g., flight management) system (at step 124). If the flight plan is not approved, the next ranked landing site is selected from the low-risk landing zones sites step 122), and the steps of generating a new flight plan (step 116), sending the flight plan to air traffic control for approval (step 118), and having the flight plan assessed by air traffic control (step 120) are repeated. These steps are repeated until a flight plan is approved by the air traffic controller.

When the flight plan is approved (step 120), it is programmed into the (e.g., flight management) system (step 124). This allows for the pilot to land safely in the selected area based on the current status of the aircraft.

FIG. 2 depicts a flow chart of the process of identifying appropriate landing sites for an emergency landing of an aircraft from the map of the reachable area (e.g., corresponding to steps 110, 112 and 114 in FIG. 1).

When the reachable area is established by the system (e.g., step 106, FIG. 1), a map of this area is established (e.g., step 108, FIG. 1). The no-go zones for this particular area are stored within a memory of the aircraft (which may be a memory of the flight management system, a memory of the system for determining the landing sites of an aircraft, or a memory of a separate system), and are converted to a map at step 200 of FIG. 2. The information corresponding to the no-go zones may be loaded into the memory and stored prior to flight. Thus, the data corresponding to the location of the no-go zones in the relevant areas may be stored in the memory of the system for determining the landing sites of an aircraft, or may be requested and loaded into the system for determining the landing sites of an aircraft at the point of use.

The map of the reachable area and the map of no-go zones are overlaid, using image processing software (step 202), in order to filter the no-go zones from the map of the reachable area.

The map of the reachable area is then further filtered by analysing the terrain of the potential landing areas, using terrain information stored within a memory of the aircraft (which may be a memory of the flight management system, a memory of the system for determining the landing sites of an aircraft or a memory of a separate system), and excluding any areas which have unsuitable terrain for landing (step 204). The terrain information may be loaded into the memory and stored prior to flight. Thus, the data corresponding to the terrain in the relevant areas may be stored in the memory of the system for determining the landing sites of an aircraft, or may be requested and loaded into the system for determining the landing sites of an aircraft at the point of use.

The aircraft landing requirements are also accounted for, such as the size of the landing strip required for the aircraft to safely decelerate upon landing (step 204). Areas which are too small are also filtered from the map (step 204).

The remaining areas of the map are then searched for the best landing sites (step 206), based on the status of the aircraft. The status of the aircraft may include how difficult it is to change the heading, how quickly the emergency landing needs to take place (for example, if there is a passenger emergency onboard), or other relevant factors to where the aircraft is able to land. These identified landing sites are then output from the image processing software as a list of landing sites (step 208), to be fed to the (e.g., flight management) system to generate a flight path to a selected landing site.

The process of identifying appropriate landing sites is executed using image processing software as demonstrated in FIG. 3, which depicts a series of maps 300, 302, 306, 310 that are filtered using the process for identifying appropriate landing sites.

The first map 300 is of the reachable area identified by system based on the aircraft manoeuvrability, fuel levels, heading, and position. This map 300 can then be overlaid with a map of the no-go zones to produce a second map 302 using image processing software.

The second map 302 has a first set of dark areas 304 representing areas where the aircraft cannot land, and so the (e.g., flight management) system cannot program a flight path to land there.

The second map 302 is further filtered to produce filtered map 306, where the second set of dark areas 308 include the first set of dark areas 304 of the second map 302. The second set of dark areas 308 are also areas where the aircraft cannot land.

The filtered map 306 is created using information relating to the terrain of the area from information stored in a memory of the aircraft, as well as information relating to the aircraft landing requirements. Terrain that is unsuitable for landing is overlaid onto the filtered map 306 as a dark area 308 by the image processing software. The remaining areas of the map that are not excluded by the no-go zones or terrain which are too small for the aircraft to feasibly land on based on the aircraft landing requirements are also included in the second set of dark areas 308. Therefore, the filtered map 306 is a map of all possible landing areas for the aircraft.

The remaining areas of the filtered map 306 are then fit with a set of rectangles 312 by the image processing software to produce landing area map 310. The rectangles 312 represent the areas the aircraft could land in, where they have been fit to be at least the minimum width and length required for the aircraft to safely land.

The largest rectangles 313 are then identified by the image processing system to produce the final map 311, with their coordinates being sent to the system as the low-risk landing sites. This allows for the system to select a landing site and generate a flight path to be sent to air traffic control by the steps described with reference to FIG. 1.

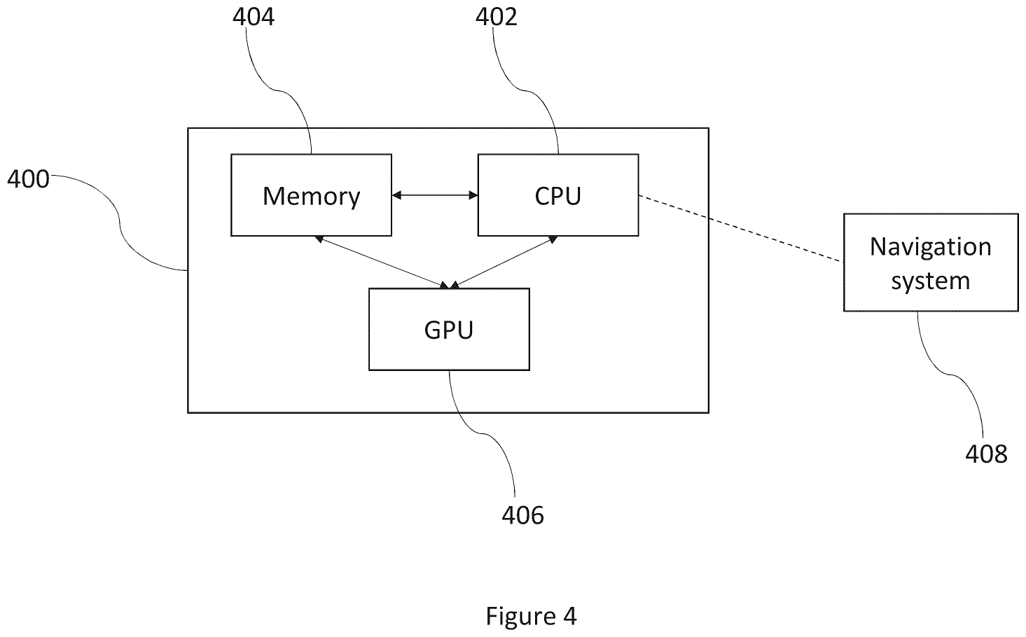

FIG. 4 shows schematically a system 400, which performs the steps described with reference to FIGS. 1-3.

The system 400 includes a central processing unit (CPU) 402, a memory 404, and a graphics processing unit (GPU) 406. The CPU 402 is configured (e.g., by executing appropriate software) to retrieve the map images, no-go zones, and terrain information from the memory 404.

The GPU 406 is configured (e.g., by executing appropriate image processing software) to process the retrieved information.

The memory 404 stores information relating to the status of the aircraft, e.g., manoeuvrability, which is also processed by the CPU 402. This information is retrieved by the CPU 402 when assessing the aircraft manoeuvrability (step 100), fuel levels (step 102), and aircraft heading and position (step 104), in order to identify the best landing sites based on aircraft landing requirements (step 204) and aircraft status (step 206). The flight management system, which may include, be part of, or be connected to the system 400 for determining the landing sites of an aircraft, then determines a flight path to the identified landing site, which is sent to the flight navigation system 408.

1. A method of determining a set of landing sites for an aircraft, wherein the method comprises:
retrieving a first map of a reachable area surrounding the aircraft;
converting data relating to a plurality of no-go zones into a second map;
filtering the plurality of no-go zones from the first map using the second map to create a third map of potential landing sites; and
identifying one or more feasible landing sites from the third map based on one or more landing requirements of the aircraft.

2. The method as claimed in claim 1, wherein the reachable area is determined from an assessment of an aircraft's manoeuvrability.

3. The method as claimed in claim 2, wherein the assessment of the aircraft's manoeuvrability uses data corresponding to steerability of the aircraft.

4. The method as claimed in claim 1, wherein the reachable area is determined using data corresponding to at least one of an aircraft heading, position, track, course, altitude, or speed.

5. The method as claimed in claim 1, wherein the reachable area is determined using data corresponding to aircraft fuel levels.

6. The method as claimed in claim 1, wherein the one or more landing requirements for the aircraft comprise at least one of a minimum length or width of a landing strip for the aircraft.

7. The method as claimed in claim 1, wherein the method comprises receiving data corresponding to a terrain profile of the reachable area.

8. The method as claimed in claim 7, wherein the method comprises identifying a plurality of low-risk landing sites from the one or more feasible landing sites using the data corresponding to the terrain profile of the reachable area.

9. The method as claimed in claim 1, wherein the method comprises:
identifying a plurality of feasible landing sites from the third map based on one or more landing requirements of the aircraft; and
ranking the plurality of feasible landing sites.

10. The method as claimed in claim 9, wherein the plurality of feasible landing sites are ranked in order of landing strip size.

11. The method as claimed in claim 9, wherein the plurality of feasible landing sites are ranked based on the distance to a landing site of the set of landing sets and a required manoeuvrability.

12. The method as claimed in claim 9, comprising selecting a highest-ranked landing site and generating a first flight plan and sending the first flight plan to an air traffic controller.

13. The method as claimed in claim 12, wherein the method comprises receiving an approval from the air traffic controller and programming the first flight plan into the aircraft.

14. The method as claimed in claim 12, wherein the method comprises:
receiving a disapproval from the air traffic controller;
selecting a second landing site;
generating a second flight plan;
sending the second flight plan to the air traffic controller;
receiving an approval form the air traffic controller; and
programming the second flight plan into the aircraft.

15. A system for determining a set of landing sites for an aircraft comprising a processor;
wherein the processor is configured to:
retrieve a first map of a reachable area surrounding the aircraft;
convert data relating to a plurality of no-go zones into a second map;
filter the plurality of no-go zones from the first map using the second map to create a third map of potential landing sites; and
identify one or more feasible landing sites from the third map based on one or more landing requirements of the aircraft.
